(19) United States
(12) Patent Application Publication
(10) Pub. No.: US 2010/0013647 A1
(43) Pub. Date: Jan. 21, 2010

(54) HYBRID POWER SYSTEM

(75) Inventors: Douglas Anthony Morris, Portland, OR (US); Dave Kelly, Atlanta, GA (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: WiSPI.net, Atlanta, GA (US)

(21) Appl. No.: 12/439,113

(22) PCT Filed: Aug. 30, 2007
(86) PCT No.: PCT/US07/77253

§ 371 Date: Feb. 26, 2009

Related U.S. Application Data
(60) Provisional application No. 60/841,011, filed on Aug. 30, 2006.
(60) Provisional application No. 60/841,059, filed on Aug. 30, 2006.
(60) Provisional application No. 60/851,120, filed on Oct. 12, 2006.
(60) Provisional application No. 60/906,344, filed on Mar. 12, 2007.

(51) Int. Cl. G08B 17/10; H01M 10/46; H02J 3/00; H02J 7/00

(52) U.S. Cl. 340/628; 320/101; 307/80; 320/124

(57) ABSTRACT

A hybrid power system for maximizing and extending the operation times of an electronic device. The hybrid power system may include a power source, an energy storage device, and a controller for maintaining the energy storage device at a desired state of charge.

### TECHNICAL FIELD

This disclosure relates generally to an electronic power system and more particularly but not exclusively, to electronic devices using a hybrid power system.

### BRIEF DESCRIPTION OF THE DRAWINGS

Understanding that drawings depict only typical embodiments of the invention and are not therefore to be considered to be limiting of its scope, the invention will be described and explained with specificity and detail through the use of the accompanying drawings as listed below.

FIG. 1 is a graph displaying a comparison of the energy content in a hybrid power system and a stand-alone battery cell.

FIG. 2 is a block diagram of an embodiment of a hybrid power system.

FIG. 3A is a cross-sectional view of an electronic device including a hybrid power system mounted on a surface.

FIG. 3B is a side view of an embodiment of an electronic device comprising a hybrid power system with external fuel cells.

FIG. 4 is a flow diagram of the functionalities of various components of an embodiment of a hybrid power system.

FIG. 5 is a flow diagram of a hybrid power system comprising a battery life extension architecture.

FIG. 6 is a schematic of a hybrid power system including a battery life extension architecture.

FIGS. 7A and 7B are graphs displaying simulated results of an embodiment of a hybrid power system under a constant voltage algorithm and at a constant voltage corresponding to a 40% state of charge at ambient temperature.

### DETAILED DESCRIPTION

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the claims, but is merely representative of various embodiments. While the various aspects of the embodiments are presented in drawings, the drawings are not necessarily drawn to scale unless specifically indicated.

As those of skill in the art will appreciate, the principles disclosed herein may be applied to and used with a variety of hybrid power systems in which the longevity of the energy storage device is maximized for an extended service life. In one embodiment, a hybrid power system may be combined with one or more energy storage devices, such as lithium-ion cells, rechargeable batteries, or capacitors. A hybrid power system may include a controller circuit configured to control the charging of the energy storage devices in order to maximize the longevity of the fuel cell system. The embodiments disclosed herein may be used in a variety of applications and with hybrid power systems of various sizes and shapes.

Several aspects of the embodiments described will be illustrated as software modules or components. As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc., that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Many commercial and consumer electronic devices employ batteries as their power source. However, because of the shelf life of batteries (the maximum being approximately 10 years for primary cells and less for rechargeable cells) and the size of the cells/batteries, many applications are limited by their power source. As such, there is a need for smaller and longer-lasting power sources for these applications. The hybrid power systems disclosed herein provide a much longer service life for an energy storage device in a hybrid power system. For example, a hybrid power system disclosed herein may be used for extended electronic battery replacement in consumer products, such as smoke alarms, gas detectors (CO₂, Carbon Monoxide, etc.), mini and microelectronics, and as a long-term energy source in many other devices and applications.

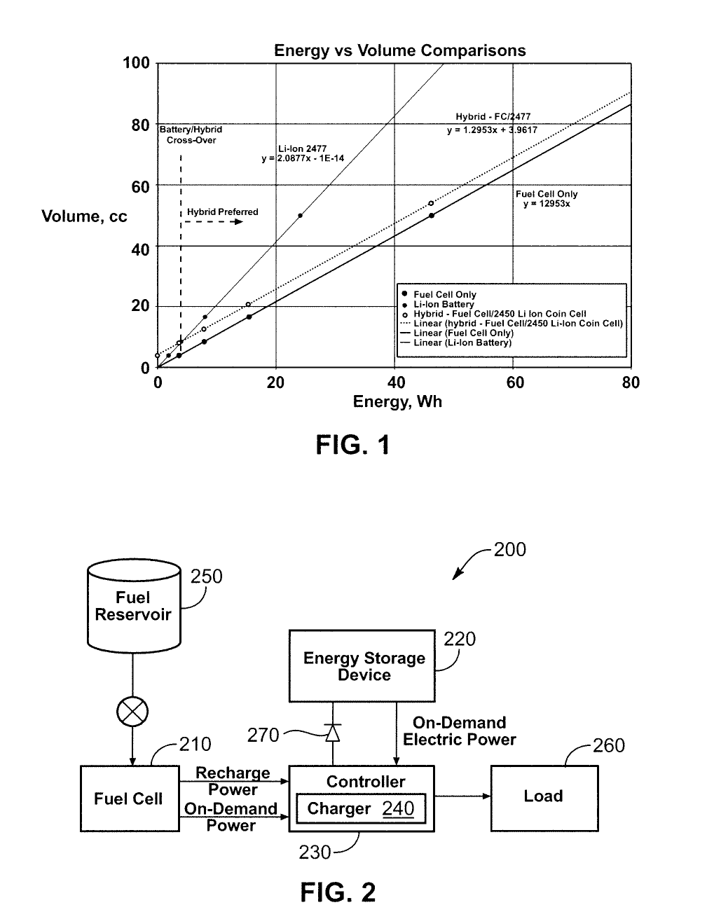

As shown in FIG. 1, a comparison of the energy content in a hybrid power system as disclosed herein and of a stand-alone battery cell is simulated for a typical low-drain, low-duty cycle, and sensor-required application. The horizontal axis includes energy in watt-hours, and the vertical axis is the volume of the fuel cell in cubic centimeters. FIG. 1 demonstrates that if extended usage is desired for an application, the battery/fuel cell hybrid power system is a better solution. A similar result can be attained for a comparison involving a capacitor/fuel cell hybrid. The capacitor/fuel cell hybrid profile lies slightly above the fuel cell/battery line because of the lower energy content of the capacitor compared to a battery. In the same line, the capacitor-alone line has a volume/energy slope much steeper than the battery-alone line.

FIG. 2 is a block diagram of an embodiment of a hybrid power system 200 including a fuel cell 210 and an energy storage device 220. The type of energy storage device 220 may be selected to meet specific energy storage and output requirements while buffering the fuel cell 210 from peak current needs of a given electrical load. The hybrid power system 200 takes advantage of the relatively high drain capabilities of the energy storage device 220 during high drain stages of a duty cycle and utilizes the low drain capabilities of the fuel cell 210 during low drain stages of a duty cycle. Furthermore, the hybrid power system 200 maintains the energy storage device 220 at a desired state of charge to allow extended operation times for a desired application.

The energy storage device 220 may include a lithium-ion (Li-Ion) cell, include nickel-cadmium (NiCd) cell, nickel metal hydride (NiMH) cell, a rechargeable battery, a capacitor or a combination of a lithium-ion cell or battery with a capacitor or other electronic energy storage devices. The fuel cell 210 may be an inorganic or organic fuel cell, direct methanol fuel cell (DMFC), reformed methanol fuel cell, direct ethanol fuel cell, proton-exchange membrane (PEM) fuel cell, microbial fuel cell, reversible fuel cell, formic acid fuel cell, a hydrogen fuel cell or direct organic fuel cells which may use hydrocarbon fuels, such as diesel, methanol, ethanol, and chemical hydrides, and the like. When connected with the energy storage device 220, the fuel cell 210 may trickle-charge the energy storage device 220 to keep it at a desired state of charge. In yet another embodiment, the fuel cell 210 may include a microfabricated chip-scale fuel cell. The fuel cell 210 may be combined with additional electrical power generation devices, such as wind or water turbines, solar cells, geothermic power collectors, and thermoelectric devices.

The hybrid power system 200 provides maximum operation times for a desired application by allowing extended longevity for the fuel cell 210 and energy storage device 220. With continued reference to FIG. 2, the hybrid power system 200 comprises a power source, such as a fuel cell 210, logic controlled circuitry, such as in a controller 230, a charger 240 that may also be a part of the controller 230, and energy storage device 220. Also, an application load 260 may be placed in electrical communication with the hybrid power system 200. The controller 230 may include a computer, a microprocessor, memory, and/or other related computer hardware and software. The controller 230 may be configured to optimize the desired voltage and current that is delivered by the hybrid power system 200 for a specific application. The application load 260 may include a number of electronic devices for consumer or commercial use including portable electronic devices, sensors, meters, monitors, wireless controls, computer accessories, and other devices that can benefit from an extended and low maintenance power supply. More particularly, the application load 260 may include wireless field sensors, weather monitors, smoke alarms and detectors, gas monitors (CO₂, Carbon Monoxide, etc.), mini and microelectronics, security system components, remote control devices, wireless computer controls, such as a wireless mouse or keyboard, etc.

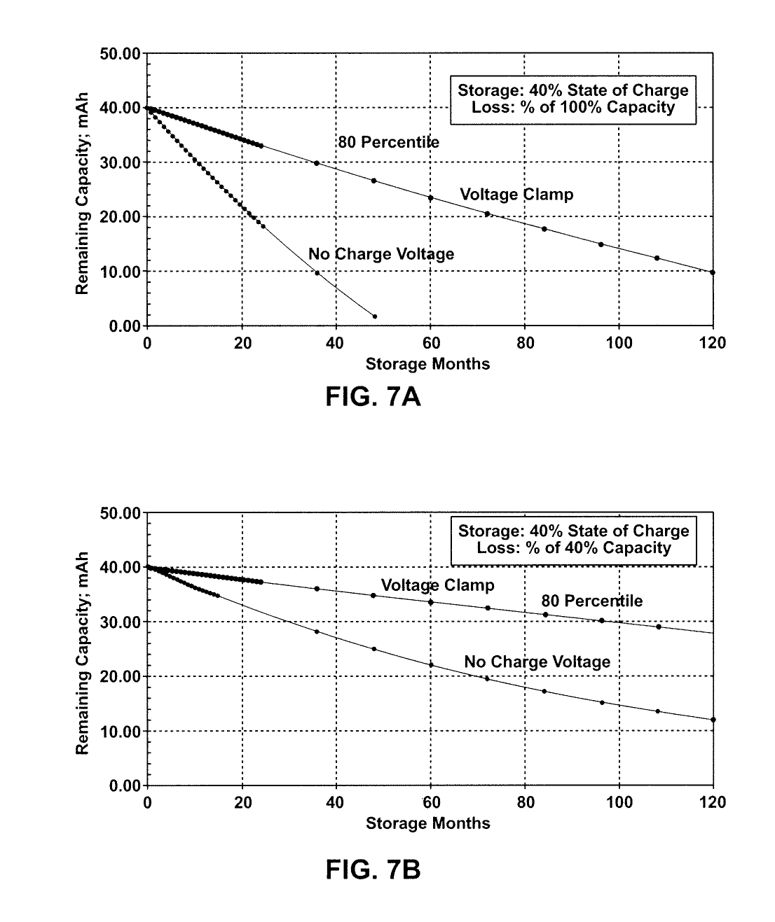

The charger 240 may be a subcomponent of the controller 230 or may be a stand-alone component in electrical communication with the controller 230. The charger 240 may be embodied as hardware, software, or a combination thereof. The charger 240 may include a charging algorithm such as a programmable executable software code, logic embedded as hardware, or a combination of software and hardware. In one embodiment, the charger 240 comprises a software module resident in a memory of the controller 230 and executable by a processor. The charger 240 may be configured to charge the energy storage device 220 at a recommended level so as to ensure extended life to the energy storage device 220. Power coming from the fuel cell 210 can be regulated by the charger 240 so that the circuit output to the energy storage device 220, such as a lithium-ion cell, is at a constant voltage. The constant voltage is chosen so as to maintain the energy storage device 220 at a desired state of charge. For example, the charger 240 may maintain the energy storage device 220 at a state of charge ranging between approximately 20% and 100% of the total charge capacity. Alternatively, the charger 240 may maintain the energy storage device 220 at a state of charge of approximately 80%, 70%, 60%, 50%, 40%, 30%, 20%, and 10% of maximum. As shown in FIGS. 7A and 7B, the charger 240 can maintain the energy storage device 220 at approximately 30% to 40% of the maximum state of charge which may allow the energy storage device 220 to be maintained at a minimum decaying state.

The charger 240 may include a charging algorithm configured to include overcharge and undercharge protection. For this functionality, the controller 230 may monitor the discharge loop to determine how much charge is required to maintain the energy storage device 220 at the required state of charge, and thus prevent over and/or undercharging.

In one embodiment, the hybrid power system 200 may be configured such that the fuel cell 210 powers the application load 260 when in stand-by mode, while the energy storage device 220 takes over during an active mode. The operation and determination of the operational mode may be performed by the controller 230. For example, the controller 230 may include operations to route the electrical power between the fuel cell 210 and the power storage device 220 or the application load 260. In one embodiment, the stand-by mode power drain may be lower than the maximum fuel cell 210 output and the active mode power drain may be lower than or equal to the maximum energy storage device output.

In one embodiment, the application load 260 may be an electronic device, such as a wireless sensor or a smoke alarm that is powered in the stand-by mode directly by the fuel cell 210. However, if the wireless sensor or the smoke alarm is activated, the high drain of the activated device may be powered directly by the energy storage device 220.

In yet another embodiment, the hybrid power system 200 may be configured so that the energy storage device 220 is used to power the load application 260 during both the low-drain and high-drain duty cycles. Once again, the controller 230 determines the operation of the hybrid power system 200 during the duty cycles. In this configuration, the controller 230 can monitor the charge levels of the energy storage device 220 and direct the fuel cell 210 to charge the energy storage device 220, thereby maintaining optimum charge levels for an extended period of time. For example, in one embodiment the application load 260 may be a portable electronic device, such as a wireless field sensor, a remote weather station, or a computer that is powered by an energy storage device 220. The hybrid power system 200 may be configured to continually maintain the charge of the energy storage device 220 at the optimum state of charge thereby increasing the maintenance intervals and reducing or eliminating the need to replace the energy storage device 220 during the life of the device.

The energy storage device 220 can be chosen to match the load requirements of the desired application. For example, an energy storage device 220, such as a capacitor, may be configured to have sufficient energy storage capacity to sustain the required power drain. Furthermore, the voltage profile of the capacitor can be such that all usable charge and capacity is contained within voltages higher than the minimum operating voltage of the application. Also, the maximum voltage of the capacitor may be such that it can be fully recharged by the fuel cell 210.

With continued reference to FIG. 2, a fuel reservoir 250 houses the fuel that the fuel cell 210 uses to generate electrical energy. The fuel may be replenished from a fuel source via a refill input or replaced with another fuel reservoir. The fuel reservoir 250 may be sized depending on usage and application. The fuel reservoir 250 supplies fuel to the fuel cell 210 which then converts the fuel into electrical energy that is used to power the controller 230.

The controller 230 may be configured to perform multiple functions, such as enable an on/off safety control of power input from the fuel cell 210, assure a timely and efficient charging of the energy storage device 220 for regulated and/or continuous use, and manage power to and from the hybrid power system 200. For example, the controller 230 may include switching controls or mechanisms that can control the supply and routing of power between the energy storage device 220, the charger 240, the logic control of controller 230, the fuel cell 210, and the application load 260. In another embodiment, the energy storage device 220 can power the controller 230 to allow continuous functioning of all circuitries. A diode 270, such as a zener diode or other limiter, may include a voltage clamping device configured to clamp the voltage flowing from the energy storage device 220 in order to avoid material corrosion potentials that may lead to cell failure.

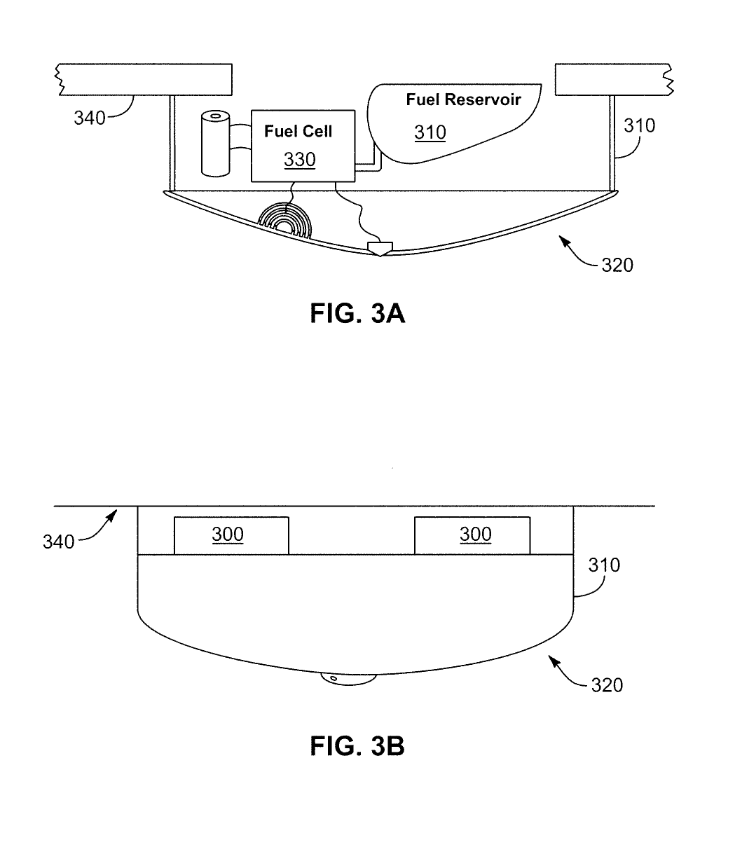

The fuel reservoir 250 may include a structure or membrane that surrounds the fuel and is resistant to corrosion by the fuel. In one embodiment, the fuel reservoir 250 may be sized and shaped to fit within a structure configured to house an electronic device. With reference to FIGS. 3A and 3B, a fuel reservoir 300 may be configured to fit within a housing 310 of an electronic device 320, such as a smoke alarm, and deliver fuel to a fuel cell, such as fuel cell 310. In another embodiment, as seen in FIG. 3A the fuel reservoir 310 may be disposed at least partially outside of the housing 310 and configured to fit in a space between the electrical device 320 and an installation surface 340. The fuel reservoir 310 may be configured to fit within the space created behind a surface-mounted electronic device 320, such as the space created by cutting away the ceiling or wall panel during the installation and mounting process. At least one fuel reservoir may be configured to be secured to the outside of the electronic device 320 which may be accessible for refilling or other maintenance.

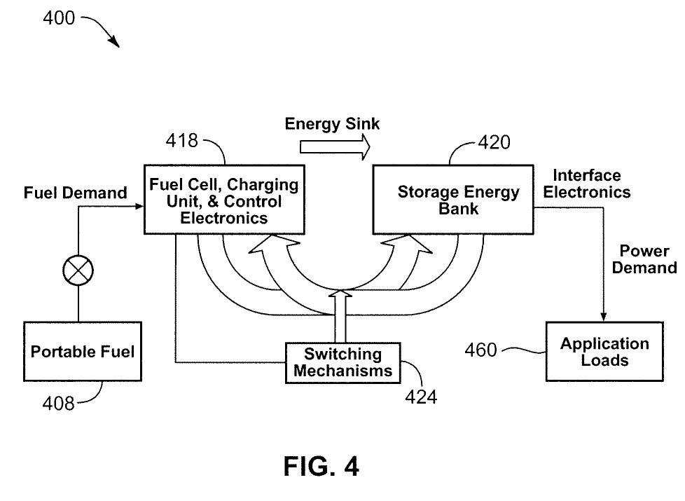

FIG. 4 is a flow diagram of components that may be included in a hybrid architecture as used in a hybrid power system 400. For example, the hybrid power system 400 can include a portable fuel source 408 which provides fuel for the fuel cell, charging unit, and control electronics of block 418. In one embodiment, the fuel cell of block 418 may be configured to supply power to the charging unit of block 418 and/or the application load 460. The charging unit of block 418 can be configured with a charging algorithm to recharge an energy storage device, such as a storage energy bank 420. The storage energy bank 420 can include one or more lithium-ion cells, rechargeable batteries, capacitors, and other energy storage devices. An electrical switch or switching control, such as switching mechanisms 424, may be integrated or in electrical communication with the control electronics of block 418 to be controlled according to the recharging needs of the storage energy bank 420, and the energy routing requirements of the fuel cell, charging unit, and control electronics of block 418 and the application load 460. In one embodiment, the power application load 460 may be one or more electronic devices, including portable devices and wireless sensors.

The hybrid power system as disclosed herein may be configured to be resistant to shock and vibration and remain stable across a range of environmental conditions, such as temperature extremes and humidity. The hybrid power system may also be configured with the desired input and output connections for a variety of electronic devices. Moreover, the hybrid power system may be sized, shaped, and packaged to meet the requirements of the desired electronic device.

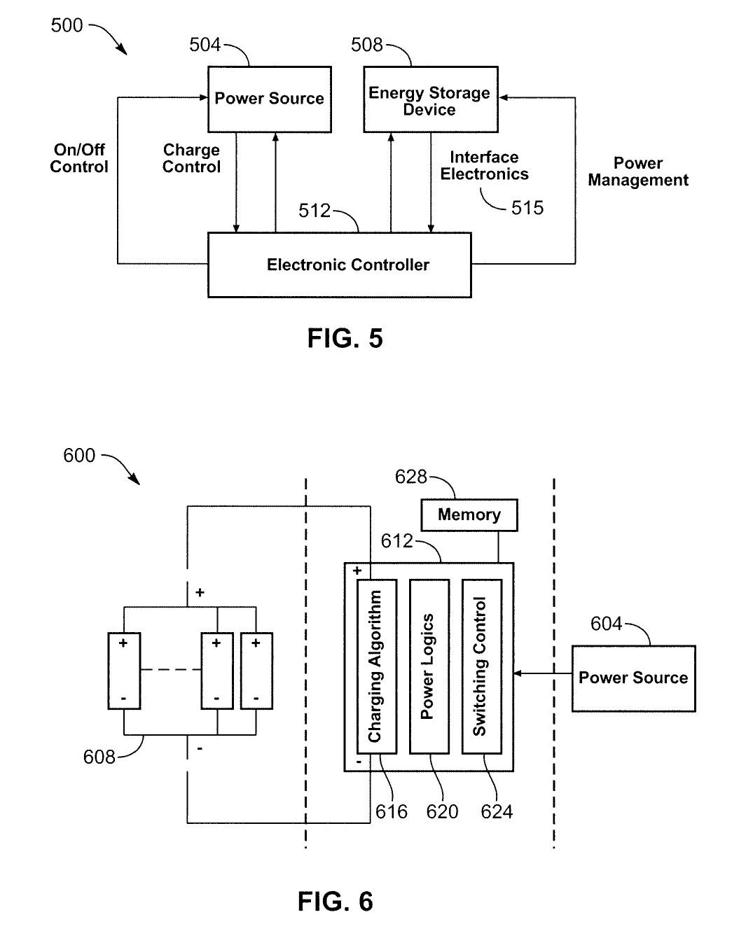

In yet another embodiment, a hybrid power system may include a battery life extension architecture for extending the life of a energy storage device, such as lithium-ion cells and/or battery packs. FIG. 5 is a block diagram of one embodiment of a battery life extension architecture 500 including a power source 504 which may be configured to supply power to an energy storage device 508 via an electronic controller 512. The power source 504 may include a fuel cell or other electrical power generation devices, such as turbines, solar cells, geothermic power collectors, and thermoelectric devices. The energy storage device 508 may comprise one or more lithium-ion cells, rechargeable batteries, or capacitors, and other energy storage devices. The electronic controller 512 may include, among other functionalities, power logic controls, one or more switching control mechanisms, and one or more charging algorithms. For example, the electronic controller 512 may be embodied with hardware and software similar to that of the controller 230 of FIG. 2. For example, the electronic controller 512 may include a computer, a microprocessor, memory, and/or other related computer hardware and software. The electronic controller 512 may be configured to enable an on-off safety control of the power input from the power source 504 and provide power management and charging control of the energy storage device 508. In one embodiment, interface electronics 515 as known in the art, or as developed for proprietary components, may also be employed between the energy storage device 508 and the electronic controller 512.

FIG. 6 is a schematic of another embodiment showing a battery life extension architecture 600 including a power source 604, such as a fuel cell, configured to supply power to an energy storage device 608 via an electronic controller 612. The electronic controller 612 may include a charging algorithm 616, a set of power logics 620, and/or a switching mechanism such as switching control 624. The charging algorithm 616 may be embodied as hardware, software, or as a combination thereof. The electronic controller 612 may include or otherwise be in electrical communication with a memory 628 in which to store the software and algorithms executed by the electronic controller 612. A charge algorithm may be embodied as a software module resident on the memory 628. The power logics 620 may include processing capability to execute the charge algorithm 616.

The battery life extension architecture 600 may be connected to the energy storage device 608 that is recharged by the power source 604 in such a way as to maintain a constant voltage across the energy storage device 608. The energy storage device 608 may be embodied as one or more batteries such as a lithium-ion cell or rechargeable batteries. In one embodiment, the cells and/or batteries of the storage device 608 may be connected in a parallel fashion as shown in FIG. 6. A load (not shown) may be further connected to the energy storage device 608 to be powered thereby with a constant voltage.

A hybrid power system comprising a battery life extension architecture like those shown in FIG. 5 and FIG. 6 may be configured to use the available energy content of a power source, such as a fuel cell, to maintain the long-term capability of an energy storage device. This is accomplished as the battery life extension architecture maintains the energy storage device at a preferred state of charge resulting in increased operation times. Furthermore, voltage regulation may protect material components from oxidation voltages that can result in loss of active material. In one embodiment, a voltage clamping device, such as a zener diode, may be used to avoid material corrosion potentials that may cause a battery failure. In yet another embodiment, a capacitor can be used as a voltage monitor wherein, when the capacitor is fully charged, a switch is closed to stop the recharging process.

FIGS. 7A and 7B display simulated results of an embodiment of a hybrid power system comprising a charging algorithm for charging an energy storage device, such as a battery, at a constant voltage corresponding to a 40% state of charge at ambient temperature (20° C.). The horizontal axis of each FIGS. 7A and 7B is the storage time in months, and the vertical axis represents the remaining capacity of the energy storage device in mAh. FIG. 7A graphs the remaining percent capacity of an energy storage device with and without a voltage clamp, as compared to the full 100% capacity of the energy storage device. FIG. 7B shows the remaining percent capacity of the energy storage device as compared to the 40% capacity of the energy storage device. FIGS. 7A and 7B show that a battery/fuel cell hybrid power system with a charging algorithm maintaining a 40% charge of the battery results in an extension of the storage life of the battery cell.

It should be emphasized that the described embodiments of this disclosure are merely possible examples of implementations and are set forth for a clear understanding of the principles of this disclosure. Many variations and modifications may be made to the described embodiments of this disclosure without departing substantially from the spirit and principles of this disclosure. All such modifications and variations are intended to be included herein within the scope of this disclosure and protected by the following claims.

1. A hybrid power system comprising:
a fuel cell;
an energy storage device in electrical communication with the fuel cell and chargeable by the fuel cell;
a controller in electrical communication with the fuel cell and the energy storage device, wherein the controller includes a charger configured to maintain the energy storage device at a desired state of charge.

2. The hybrid power system of claim 1, further comprising a switching mechanism in electrical communication with the controller and configured to switch between providing power to an application load from the energy storage device and providing power to an application load from the fuel cell.

3. The hybrid power system of claim 1, further comprising a voltage clamping device in electrical communication with the energy storage device and configured to limit the amount of voltage attainable by the energy storage device.

4. The hybrid power system of claim 1, wherein the energy storage device is a lithium-ion cell.

5. The hybrid power system of claim 1, wherein the energy storage device is a rechargeable battery.

6. The hybrid power system of claim 1, wherein the energy storage device is a capacitor.

7. The hybrid power system of claim 1, wherein the desired state of charge of the energy storage device ranges from 30% to 40% of a maximum charge capacity.

8. The hybrid power system of claim 1, wherein the controller comprises a memory and wherein the charger comprises a computer executable resident on the memory.

9. The hybrid power system of claim 1, wherein the desired state of charge of the energy storage device ranges from 40% to 50% of a maximum charge capacity.

10. The hybrid power system of claim 1, wherein the desired state of charge of the energy storage device ranges from 50% to 60% of a maximum charge capacity.

11. The hybrid power system of claim 1, wherein the desired state of charge of the energy storage device ranges from 60% to 70% of a maximum charge capacity.

12. A hybrid power system comprising:
a plurality of power storage devices;
a power source in electrical communication with the plurality of power storage devices to recharge the plurality of power storage devices;
a controller comprising power logic circuitry and at least one switching control to control the recharging of the power storage devices; and
a charger configured to maintain the plurality of energy storage devices at a desired state of charge and below a maximum charge capacity.

13. The hybrid power system of claim 12, wherein the power source is a fuel cell.

14. The hybrid power system of claim 12, wherein the charger maintains the plurality of power storage devices at a substantially constant voltage.

15. The hybrid power system of claim 12, further comprising at least one switching mechanism configured to switch between providing power to an application load from the plurality of energy storage devices and from the power source.

16. The hybrid power system of claim 12, further comprising:
a voltage clamping device in electrical communication with the plurality of energy storage devices and configured to limit the amount of voltage attainable by the plurality of energy storage devices.

17. An electronic device comprising:
an application load;
a hybrid power system configured to power the application load, wherein the hybrid power system comprises a fuel cell and an energy storage device in electrical communication with the fuel cell;
a controller comprising power logic circuitry and at least one switching control to control the recharging of the power storage device; and
a charger configured to maintain the energy storage device at a desired state of charge and below a maximum charge capacity.

18. The electronic device of claim 17, further comprising a fuel reservoir configured to deliver fuel to the fuel cell.

19. The electronic device of claim 17, wherein the energy storage device is a lithium-ion cell.

20. The electronic device of claim 17, wherein the energy storage device is a capacitor.

21. The electronic device of claim 17, wherein the electronic device is selected from the group consisting of wireless sensors, weather monitors, smoke alarms and detectors, gas monitors, consumer electronics, security system components, remote control devices, wireless computer controls, and combinations thereof.

22. A smoke detector for alerting a user of a potential fire hazard, the smoke detector comprising:
an alarm configured to be activated upon the detection of smoke;
a hybrid power system configured to power the smoke detector, wherein the hybrid power system comprises a fuel cell, a fuel reservoir for providing fuel to the fuel cell, and an energy storage device in electrical communication with the fuel cell;
a controller comprising power logic circuitry and at least one switching control to control the recharging of the power storage device; and
a charger configured to maintain the energy storage device at a desired state of charge and below a maximum charge capacity.

23. The smoke detector of claim 22, wherein the controller is configured to route power from the power storage device to the alarm when the alarm is activated.

24. The smoke detector of claim 22, further comprising a structure for housing the smoke detector, wherein the fuel reservoir is at least partially disposed within the structure.

25. The smoke detector of claim 22, further comprising a structure for housing the smoke detector, wherein the fuel reservoir is at least partially disposed outside of the structure.
